(19) United States
(12) Patent Application Publication
(10) Pub. No.: US 2025/0314598 A1
(43) Pub. Date: Oct. 9, 2025

(54) INSPECTING EQUIPMENT AND METHOD THEREOF

(71) Applicant: NANYA TECHNOLOGY CORPORATION, New Taipei city (TW)

(72) Inventor: Yi-Wen LIU, New Taipei City (TW)

(21) Appl. No.: 18/626,571

(22) Filed: Apr. 4, 2024

(51) Int. Cl. G01N 21/88; B25J 9/16; B25J 19/02

(52) U.S. Cl. CPC G01N 21/8851; B25J 9/1669; B25J 19/022; B25J 19/023; G01N 21/8806; G01N 2021/8887

(57) ABSTRACT

An inspecting equipment includes a main body, an optical device, an analyzing device and a robot arm. The optical device is configured to obtain an image of a surface. The analyzing device is signally connected with the optical device. The analyzing device is configured to analyze the image obtained to identify any protrusion on the surface. The robot arm is connected between the optical device and the main body. The robot arm is configured to move the optical device relative to the main body.

### BACKGROUND

### Technical Field

The present disclosure relates to inspecting equipment and the inspecting method using such inspecting equipment. More particularly, the present disclosure relates to inspection to the inner surface of a front opening unified pod (FOUP).

### Description of Related Art

As the demand for electronic devices has been increasing nowadays, the quality of various components of electronic devices becomes an important issue of the industry. Apart from improving the technology of manufacture of the components, the measures to guarantee the quality of the components during production is also highly concerned.

For example, front opening unified pods (FOUPs) are commonly used to accommodate wafers during the production process in the industry of semiconductors. Hence, the measures to guarantee a good condition of the FOUPs are important to increase the yield rate of the wafers and thus help to decrease the cost of production.

### SUMMARY

A technical aspect of the present disclosure is to provide an inspecting equipment, which can inspect the inner surface of the front opening unified pod (FOUP) for the presence of any protrusion in an efficient and reliable manner.

According to an embodiment of the present disclosure, an inspecting equipment includes a main body, an optical device, an analyzing device and a robot arm. The optical device is configured to obtain an image of a surface. The analyzing device is signally connected with the optical device. The analyzing device is configured to analyze the image obtained to identify any protrusion on the surface. The robot arm is connected between the optical device and the main body. The robot arm is configured to move the optical device relative to the main body.

In one or more embodiments of the present disclosure, the optical device is a camera.

In one or more embodiments of the present disclosure, the analyzing device is configured to analyze the image obtained by artificial intelligence.

In one or more embodiments of the present disclosure, the robot arm is further configured to rotate the optical device.

According to an embodiment of the present disclosure, an inspecting equipment includes a main body, a profiler, an analyzing device and a robot arm. The profiler is configured to obtain a profile of a surface. The analyzing device is signally connected with the profiler. The analyzing device is configured to analyze the profile obtained to identify any protrusion on the surface. The robot arm is connected between the profiler and the main body. The robot arm is configured to move the profiler relative to the main body.

In one or more embodiments of the present disclosure, the profiler is a laser profiler configured to emit a laser beam to the surface and receive the laser beam reflected from the surface.

In one or more embodiments of the present disclosure, the analyzing device identifies a protrusion on the surface when a variation of the profile obtained exceeds a predetermined value.

In one or more embodiments of the present disclosure, the robot arm is further configured to rotate the profiler.

A technical aspect of the present disclosure is to provide an inspecting method, which can inspect the inner surface of the front opening unified pod (FOUP) for the presence of any protrusion in an efficient and reliable manner.

According to an embodiment of the present disclosure, an inspecting method includes inserting an inspecting module at least partially into a space of a FOUP; and inspecting an inner surface of the FOUP by the inspecting module to identify any protrusion on the inner surface.

In one or more embodiments of the present disclosure, the procedure of inspecting the inner surface of the FOUP includes obtaining an image of the inner surface; and analyzing the image obtained.

In one or more embodiments of the present disclosure, the procedure of analyzing the image obtained includes analyzing by artificial intelligence.

In one or more embodiments of the present disclosure, the procedure of inspecting the inner surface of the FOUP includes obtaining a profile of the inner surface; and analyzing the profile obtained.

In one or more embodiments of the present disclosure, the procedure of obtaining the profile of the inner surface includes emitting a laser beam across the inner surface; and receiving the laser beam reflected from the inner surface.

In one or more embodiments of the present disclosure, the procedure of analyzing the profile obtained includes identifying a protrusion on the inner surface when a variation of the profile obtained exceeds a predetermined value.

In one or more embodiments of the present disclosure, the procedure of inserting the inspecting module into the space of the FOUP includes moving the inspecting module by a robot arm.

In one or more embodiments of the present disclosure, the robot arm is further configured to at least partially rotate the inspecting module.

The above-mentioned embodiments of the present disclosure have at least the following advantages: since the inspecting module is employed in the present disclosure, the inspection of the inner surface of the FOUP for the presence of any protrusion becomes more efficient and reliable.

### BRIEF DESCRIPTION OF THE DRAWINGS

The disclosure can be more fully understood by reading the following detailed description of the embodiments, with reference made to the accompanying drawings as follows:

FIG. 1 is a flow chart of an inspecting method according to an embodiment of the present disclosure;

FIG. 2 is a partially sectional side view of an inspecting equipment according to an embodiment of the present disclosure;

FIG. 3 is a cross-sectional view along the section line A-A of FIG. 2;

FIG. 4 is a partially sectional top view of an inspecting equipment according to another embodiment of the present disclosure;

FIG. 5 is a graphical presentation showing a profile obtained by the profiler of FIG. 4; and

FIG. 6 is a partially sectional top view of the inspecting equipment of FIG. 4, in which the profiler is rotated by the robot arm.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

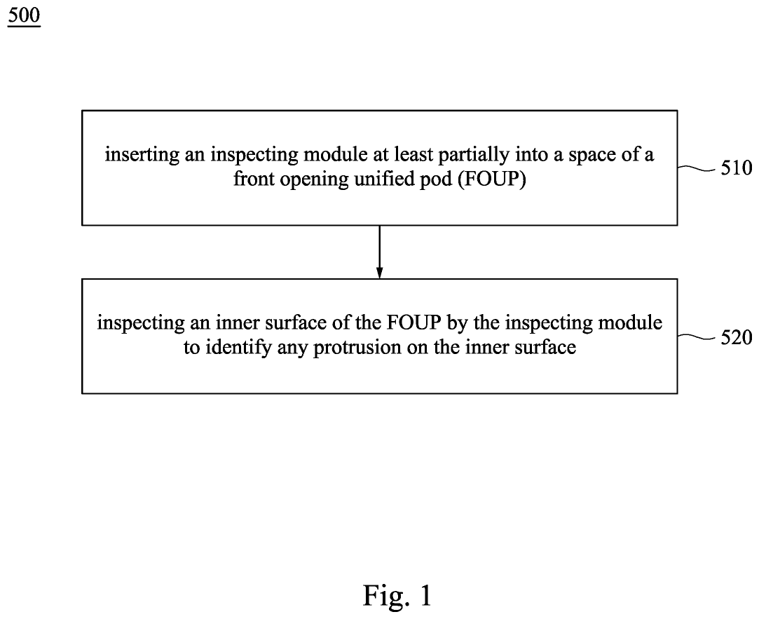

Reference is made to FIG. 1. FIG. 1 is a flow chart of an inspecting method 500 according to an embodiment of the present disclosure. In this embodiment, as shown in FIG. 1, the inspecting method 500 includes the following procedures, which should be understood that the order of procedures mentioned below can be changed as per actual requirements, and some of the procedures may be executed simultaneously or partially simultaneously unless their sequence is explicitly stated:

(1) Procedure 510: inserting an inspecting module 120 at least partially into a space S of a front opening unified pod (FOUP) 200.

(2) Procedure 520: inspecting an inner surface 210 of the FOUP 200 by the inspecting module 120 to identify any protrusion on the inner surface 210. It is noted that the inner surface 210 defines the space S.

In practice, a FOUP 200 is commonly used to accommodate a plurality of wafers (not shown). During the manufacturing process of a FOUP 200, unexpected protrusion(s) may appear on the inner surface 210 of the FOUP 200. The protrusion(s) may exist in a structural form of bubble and contain unwanted airborne molecular particles therein. In case the protrusion(s) is ruptured, the unwanted airborne molecular particles may come out of the protrusion and the wafers accommodated in the FOUP 200 will be under a high risk of being contaminated by these unwanted airborne molecular particles. Therefore, in order to maintain a high production efficiency of wafers, when a protrusion is identified in the inner surface 210 of a FOUP 200 by the inspecting module 120, this FOUP 200 will be repaired first before it is used again to accommodate the wafers. Since the inspecting module 120 is employed in the present disclosure, the inspection of the inner surface 210 of the FOUP 200 for the presence of any protrusion becomes more efficient and reliable.

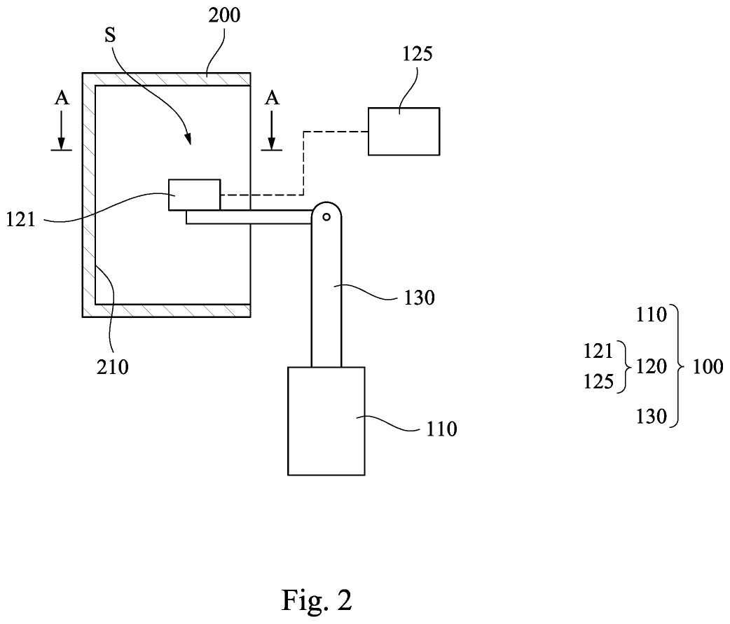

Reference is made to FIG. 2. FIG. 2 is a partially sectional side view of an inspecting equipment 100 according to an embodiment of the present disclosure. In this embodiment, as shown in FIG. 2, an inspecting equipment 100 is provided to execute the inspecting method 500 mentioned above. The inspecting equipment 100 includes a main body 110, a robot arm 130 and the inspecting module 120. The inspecting module 120 includes an optical device 121 and an analyzing device 125. The optical device 121 is configured to obtain an image of the inner surface 210. The analyzing device 125 is signally connected with the optical device 121. The analyzing device 125 is configured to analyze the image obtained to identify any protrusion on the inner surface 210. The robot arm 130 is connected between the optical device 121 and the main body 110. The robot arm 130 is configured to move the optical device 121 relative to the main body 110, such that the optical device 121 can be inserted into the space S of the FOUP 200.

To be specific, for example, the optical device 121 in FIG. 2 points to the inner surface 210 at the left side of the figure, and obtain the image of the inner surface 210. The analyzing device 125 then analyzes the image obtained to identify if there is any protrusion on the inner surface 210.

In practical applications, the optical device 121 is a camera. However, this does not intend to limit the present disclosure.

Furthermore, in order to increase the analyzing performance, the analyzing device 125 is configured to analyze the image obtained by artificial intelligence. In other words, the analyzing device 125 is installed with a software of artificial intelligence.

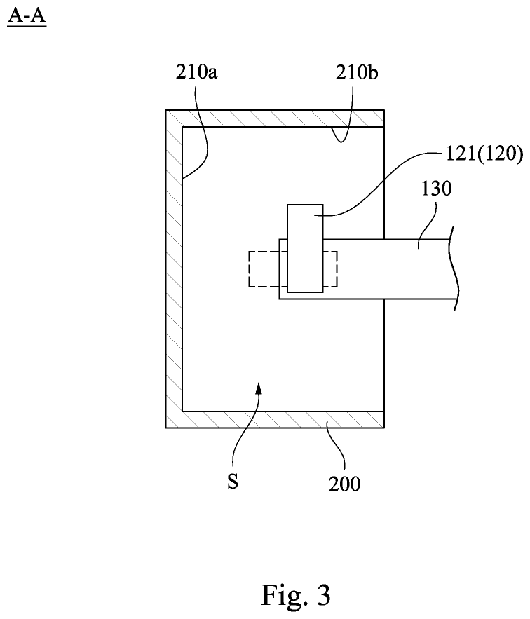

Reference is made to FIG. 3. FIG. 3 is a cross-sectional view along the section line A-A of FIG. 2. In this embodiment, the robot arm 130 is further configured to rotate the optical device 121. As shown in FIG. 3, the optical device 121 is rotated from its original position (in hidden lines) pointing to the inner surface 210a to a new position pointing to the inner surface 210b. The inner surface 210b is adjacent to the inner surface 210a. Therefore, it can be understood that, the inner surface 210 of the FOUP 200 at different positions can be inspected by the inspecting module 120.

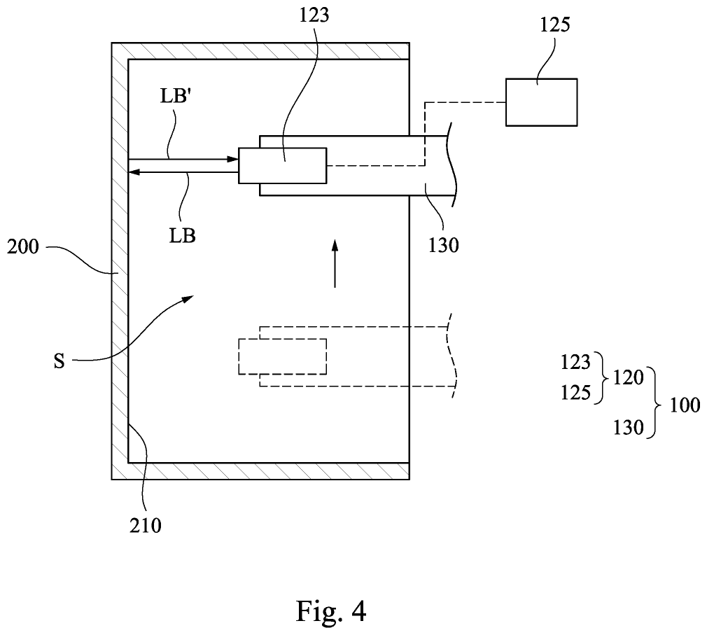

Reference is made to FIG. 4. FIG. 4 is a partially sectional top view of an inspecting equipment 100 according to another embodiment of the present disclosure. In this embodiment, as shown in FIG. 4, the inspecting module 120 includes a profiler 123 instead of the optical device 121 mentioned in the previous embodiment. The profiler 123 is configured to obtain a profile of the inner surface 210. The analyzing device 125 of the inspecting module 120 is signally connected with the profiler 123. The analyzing device 125 is configured to analyze the profile obtained to identify any protrusion on the inner surface 210. The robot arm 130 is connected between the profiler 123 and the main body 110 (please see FIG. 2 as reference for the main body 110). The robot arm 130 is configured to move the profiler 123 relative to the main body 110, such that the profiler 123 can be inserted into the space S of the FOUP 200.

In practical applications, the profiler 123 is a laser profiler which is configured to emit a laser beam LB to the inner surface 210 and receive the laser beam LB′ reflected from the inner surface 210. As shown in FIG. 4, when the profiler 123 is moved by the robot arm 130 relative to the inner surface 210 from its original position (in hidden line) to a new position, the laser profiler 123 keeps emitting a laser beam LB across the inner surface 210 and receiving the laser beam LB′ reflected from the inner surface 210. In this way, a profile of the inner surface 210 is obtained. Consequently, the analyzing device 125 identifies if there is any protrusion on the inner surface 210.

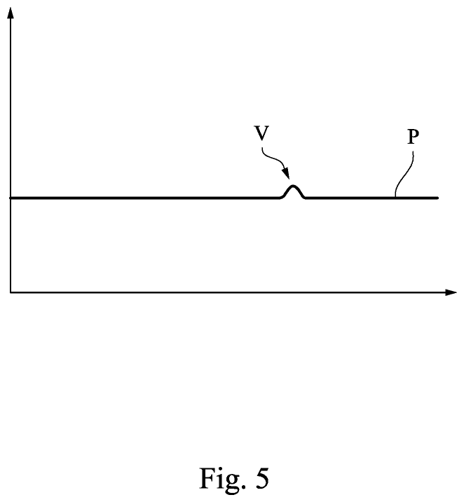

Reference is made to FIG. 5. FIG. 5 is a graphical presentation showing a profile P obtained by the profiler 123 of FIG. 4. In this embodiment, as shown in FIG. 5, when there is a variation V in the profile P obtained and this variation V exceeds a predetermined value, the analyzing device 125 can then identify a protrusion on the inner surface 210 of the FOUP 200 at the corresponding location.

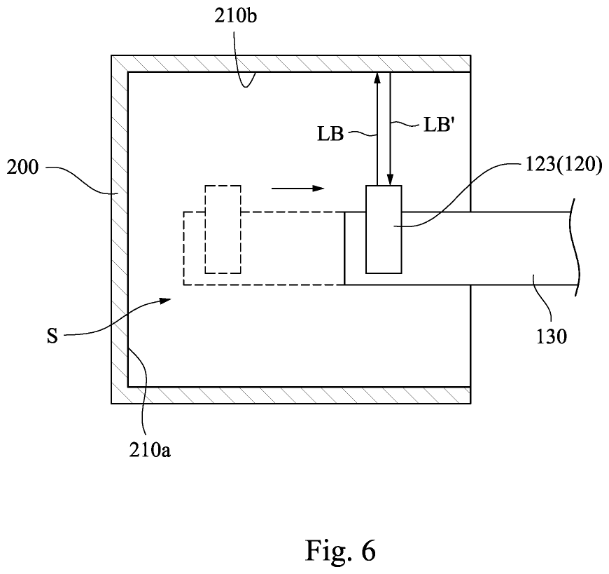

Reference is made to FIG. 6. FIG. 6 is a partially sectional top view of the inspecting equipment 100 of FIG. 4, in which the profiler 123 is rotated by the robot arm 130. In this embodiment, the robot arm 130 is further configured to rotate the profiler 123. As shown in FIG. 6, the profiler 123 is rotated from its original position (in hidden lines) pointing to the inner surface 210a to a new position pointing to the inner surface 210b adjacent to the inner surface 210a, and the profiler 123 is moved by the robot arm 130 across the inner surface 210b from its original position (in hidden line) to a new position. Therefore, it can be understood that, the inner surface 210 of the FOUP 200 at different positions can be inspected by the inspecting module 120.

In other embodiments, according to the actual situation, the inspecting module 120 may include both of the profiler 123 and the optical device 121, while the analyzing device 125 is configured to analyze the profile obtained by the profiler 123 and the image obtained by the optical device 121, in order to identify any protrusion on the inner surface 210.

In conclusion, the aforementioned embodiments of the present disclosure have at least the following advantages: since the inspecting module is employed in the present disclosure, the inspection of the inner surface of the FOUP for the presence of any protrusion becomes more efficient and reliable.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An inspecting equipment, comprising:
a main body;
an optical device configured to obtain an image of a surface;
an analyzing device signally connected with the optical device, the analyzing device being configured to analyze the image obtained to identify any protrusion on the surface; and
a robot arm connected between the optical device and the main body, the robot arm being configured to move the optical device relative to the main body.

2. The inspecting equipment of claim 1, wherein the optical device is a camera.

3. The inspecting equipment of claim 1, wherein the analyzing device is configured to analyze the image obtained by artificial intelligence.

4. The inspecting equipment of claim 1, wherein the robot arm is further configured to rotate the optical device.

5. An inspecting equipment, comprising:
a main body;
a profiler configured to obtain a profile of a surface;
an analyzing device signally connected with the profiler, the analyzing device being configured to analyze the profile obtained to identify any protrusion on the surface; and
a robot arm connected between the profiler and the main body, the robot arm being configured to move the profiler relative to the main body.

6. The inspecting equipment of claim 5, wherein the profiler is a laser profiler configured to emit a laser beam to the surface and receive the laser beam reflected from the surface.

7. The inspecting equipment of claim 5, wherein the analyzing device identifies a protrusion on the surface when a variation of the profile obtained exceeds a predetermined value.

8. The inspecting equipment of claim 5, wherein the robot arm is further configured to rotate the profiler.

9. An inspecting method, comprising:
inserting an inspecting module at least partially into a space of a front opening unified pod (FOUP); and
inspecting an inner surface of the FOUP by the inspecting module to identify any protrusion on the inner surface.

10. The method of claim 9, wherein inspecting the inner surface of the FOUP comprises:
obtaining an image of the inner surface; and
analyzing the image obtained.

11. The method of claim 10, wherein analyzing the image obtained comprises:
analyzing by artificial intelligence.

12. The method of claim 9, wherein inspecting the inner surface of the FOUP comprises:
obtaining a profile of the inner surface; and
analyzing the profile obtained.

13. The method of claim 12, wherein obtaining the profile of the inner surface comprises:
emitting a laser beam across the inner surface; and
receiving the laser beam reflected from the inner surface.

14. The method of claim 12, wherein analyzing the profile obtained comprises:
identifying a protrusion on the inner surface when a variation of the profile obtained exceeds a predetermined value.

15. The method of claim 9, wherein inserting the inspecting module into the space of the FOUP comprises:
moving the inspecting module by a robot arm.

16. The method of claim 15, wherein the robot arm is further configured to at least partially rotate the inspecting module.
